(19) United States
(12) Patent Application Publication
(10) Pub. No.: US 2026/0211927 A1
(43) Pub. Date: Jul. 23, 2026

(54) INTERFACE FOR IDENTIFYING AND DISPLAYING ELECTRONIC FORM ANOMALIES

(71) Applicant: Intuit Inc., Mountain View, CA (US)

(72) Inventors: John SAMUEL, Bengaluru (IN); Vishal Kumar SINGH, Bengaluru (IN); Srivathsal Venkataramu, Bengaluru (IN); Sanjay KUMAR, Bengaluru (IN); Sandeep MEWARA, Bengaluru (IN); Vimalkumar Dhirajlal MAKADIA, Bengaluru (IN); Chandrakanth SIVARAMAN, Bengaluru (IN)

(73) Assignee: Intuit Inc., Mountain View, CA (US)

(21) Appl. No.: 19/030,661

(22) Filed: Jan. 17, 2025

(51) Int. Cl. G06F 16/34; G06F 3/04842

(52) U.S. Cl. CPC G06F 16/345; G06F 3/04842

(57) ABSTRACT

A method including receiving an electronic form including a structured language data structure storing form data in fields. A prompt is generated, including text for commanding a language model to compare a context to the structured language data structure to generate a comparison, and to identify, based on the comparison, an anomaly between the context and the structured language data structure. A field is mapped to the anomaly. The structured language data structure is modified to generate a modified structured language data structure. Modifying includes adding computer code to the structured language data structure. The computer code is programmed, when executed, to add a selectable link to the field based on at least one of the anomaly, the structured language data structure, and the field. The selectable link, when selected, launches an application. The modified structured language data structure is rendered on a display device together with the selectable link.

### BACKGROUND

Some electronic forms may be complicated, and further may include multiple interacting electronic forms. For example, preparing electronic tax returns may involve preparing multiple interacting electronic forms. Such complex electronic forms may be prone to errors or may contain violations of external rules. Errors, violations, and uncertainties in such electronic forms may be referred to as anomalies.

Automatically checking such electronic forms for anomalies may be difficult. Additionally, selecting an appropriate application for mitigating an anomaly in such electronic forms also may be difficult. For example, selecting the correct tax software product, or selecting the correct subroutine within a tax software product for correcting a given anomaly also may be difficult. Launching such an application also may be difficult, or may be beyond the authority of a user of the application (e.g., when the user is using a restricted web-based application).

Thus, a technical problem is presented. The technical problem is determining how to display one or more anomalies in complex electronic forms and then launching the correct software application for mitigating the anomalies.

### SUMMARY

One or more embodiments provide for a method. The method includes receiving an electronic form including a structured language data structure storing form data in a number of fields. The method also includes generating a prompt including text for commanding a language model to compare a context to the structured language data structure to generate a comparison, and to identify, based on the comparison, an anomaly between the context and the structured language data structure. The method also includes executing the language model with the prompt to output the anomaly. The method also includes mapping a field of the fields to the anomaly. The method also includes modifying the structured language data structure to generate a modified structured language data structure. Modifying includes adding computer code to the structured language data structure. The computer code is programmed, when executed, to add a selectable link to the field based on at least one of the anomaly, the structured language data structure, and the field. The selectable link, when selected, launches an application selected from among a number of applications. The method also includes rendering, on a display device, the modified structured language data structure, including rendering the field together with the selectable link.

One or more embodiments also provide for a system. The system includes a computer processor and a number of applications executable by the computer processor. The system also includes a language model executable by the computer processor. The system also includes a data repository in communication with the computer processor. The data repository stores an electronic form including a structured language data structure storing form data in a number of fields including a field. The data repository also stores a prompt including text for commanding the language model. The data repository also stores a context. The data repository also stores an anomaly between the context and the structured language data structure. The data repository also stores a modified structured language data structure. The data repository also stores computer code programmed, when executed, to add a selectable link to the field based on at least one of the anomaly, the structured language data structure, and the field. The selectable link, when selected, launches an application selected from among the applications. The system also includes a server controller which, when executed by the computer processor, performs a computer-implemented method. The computer-implemented method also includes receiving the electronic form. The computer-implemented method also includes generating the prompt to command the language model to compare the context to the structured language data structure to generate a comparison and to identify, based on the comparison, the anomaly. The computer-implemented method also includes executing the language model with the prompt to output the anomaly. The computer-implemented method also includes mapping the field to the anomaly. The computer-implemented method also includes modify the structured language data structure to generate the modified structured language data structure having the computer code. The computer-implemented method also includes generating a command to render, on a display device, the modified structured language data structure, including rendering the field together with the selectable link.

One or more embodiments provide for another method. The method includes receiving an electronic form including a structured language data structure storing form data in a number of fields. The method also includes generating a prompt including text for commanding a language model to compare a context to the structured language data structure to generate a comparison, to identify, based on the comparison, an anomaly between the context and the structured language data structure, and to add a second command to the prompt to summarize context text contained in the context to generate summarized text, the context text being related to the anomaly. The method also includes executing the language model with the prompt to output the anomaly and to generate the summarized text. The method also includes mapping a field of the fields to the anomaly. The method also includes modifying the structured language data structure to generate a modified structured language data structure. Modifying includes adding computer code to the structured language data structure. The computer code is programmed, when executed, to add a selectable link to the field based on at least one of the anomaly, the structured language data structure, and the field. The selectable link, when selected, launches an application selected from among a number of applications. The method also includes rendering, on a display device, the modified structured language data structure, including rendering the field together with the selectable link. The method also includes rendering, on the display device as associated with the field, the summarized text. The method also includes receiving a user selection of the selectable link. The method also includes executing, responsive to the user selection of the selectable link, the application on at least one of the structured language data structure and the modified structured language data structure. The method also includes editing, by the application, the field to further modify at least one of the structured language data structure and the modified structured language data structure. Editing generates a corrected structured language data structure. The method also includes returning the corrected structured language data structure.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method in accordance with one or more embodiments.

FIG. 3 shows a dataflow of a method in accordance with one or more embodiments.

FIG. 4 shows an example of a interface for identifying and displaying electronic form anomalies, in accordance with one or more embodiments.

FIG. 5A and FIG. 5B shows a computing system and a network environment, in accordance with one or more embodiments.

Like elements in the various figures are denoted by like reference numerals for consistency.

### DETAILED DESCRIPTION

One or more embodiments are directed to determining how to display one or more anomalies in complex electronic forms and then launching the correct software application for mitigating the anomalies. Briefly, one or more embodiments first identify the anomaly from a structured language data structure defining the electronic form, then map the anomaly to a field of a structured language data structure, and modify the structured language data structure to include a selectable link to the appropriate application for mitigating the anomaly. The selectable link is selectable to launch the appropriate application, which then may be used to correct or otherwise mitigate the anomaly as expressed in the structured language data structure.

As indicated above, in an embodiment, the structured language data structure that defines an electronic form first may be checked for anomalies. A structured language data structure is a data structure holding data in the format of a structured language. An example of a structured language data structure is a JAVASCRIPT® object notation (JSON) file, though many different types of structured language data structures exist.

A structured language data structure is particularly useful for controlling the output of a language model. Thus, one or more embodiments may generate a prompt (i.e., a command to the language model as expressed in text) that commands the language model to compare the structured language data structure to a context in order to identify anomalies. A context is a source of reference material. Thus, for example, if the structured language data structure is used to store one or more tax forms, then the context may be tax rules.

If the language model outputs a determination that one or more fields in the structured language data structure contain an anomaly, then a mapping is performed between the anomaly and a field of the structured language data structure that is determined to be anomalous. For example, a mapping is performed between a violation detected by the language model and a field in the structured language data structure that defines an electronic tax form. A mapping means that the field is marked or recorded as containing an anomaly or otherwise being anomalous.

Then, the structured language data structure is modified to contain a selectable link. In particular, when the structured language data structure is rendered, the selectable link is displayed on a display device as a selectable link (e.g., a hyperlink). In an embodiment, the field (or fields) containing the anomaly (or anomalies) may be highlighted and displayed as selectable links. The selectable link or links each are links to one or more applications suitable for correcting the anomaly or anomalies.

Thus, a user or automated process may use the selectable link to launch the appropriate application for mitigating one or more anomalies. Once the anomalies are mitigated, the structured language data structure is updated. The final corrected structured language data structure then may be returned (e.g., further processed, submitted to an authority, stored, etc.)

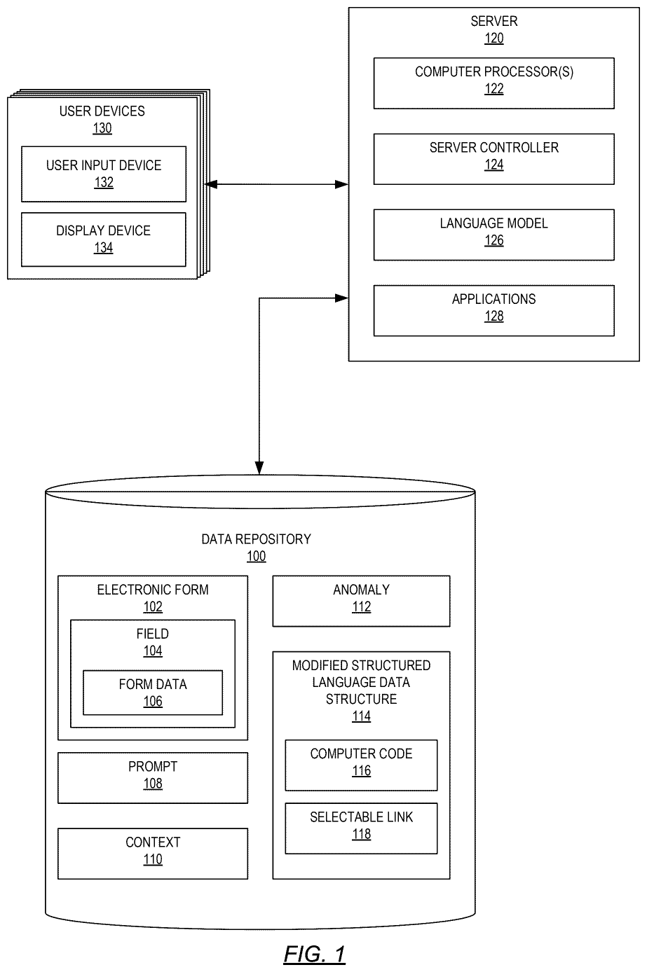

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores an electronic form (102). The electronic form (102) is a structured language data structure that contains data that, when rendered by a processor, may be used to display a form on a display device. A structured language data structure is a type of data structure expressed in a structured language. An example of a structured language data structure is a JAVASCRIPT® (by ORACLE AMERICA, INC.) object notation (JSON) file. However, other types of structured language data structures exist, including tables, graph databases, etc. In any case, the structured language data structure is storable on a non-transitory computer readable storage medium.

The data repository (100) includes a field (104). The field (104) is a portion of the electronic form (102) that may contain a value that expresses a type of data. For example, the field (104) may be a definition of a data type in the structured language data structure. When displayed, the field (104) may be shown as a type of information which may change depending on the value shown on the field (e.g., a dollar amount field in an electronic tax form, a name field on the electronic form, etc.).

In turn, the field (104) may store form data (106). The form data (106) may be a value, expressed in terms of alphanumeric text, which corresponds to field (104). For example, the form data (106) may be the dollar value for the dollar amount in the electronic tax form, the name filed on the electronic form, etc.

Note that the electronic form (102) may include many different fields, of which the field (104) is one. Similarly, electronic form (102) may include many different entries of the form data (106), including the form data (106) for the field (104). Furthermore, the field (104) may include multiple values in some cases for the field (104).

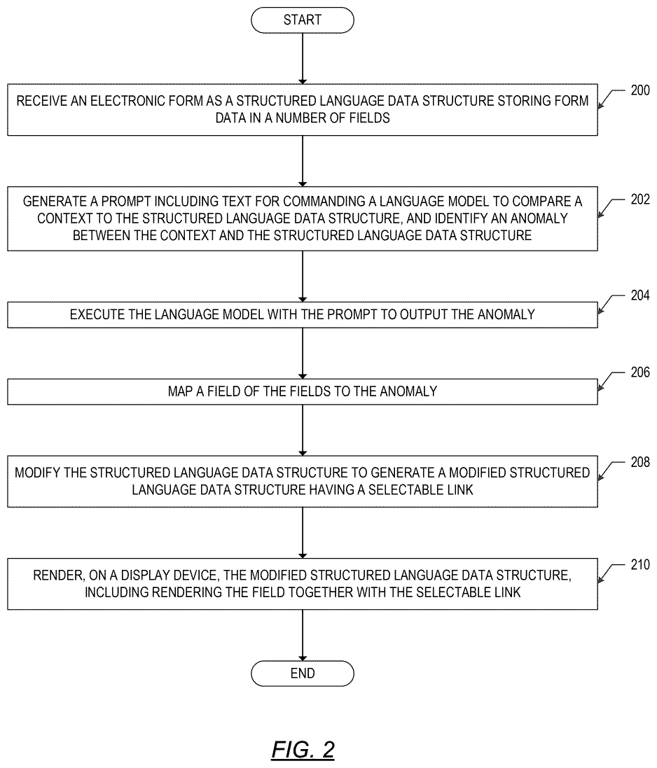

The data repository (100) also may store a prompt (108). The prompt (108) is alphanumeric text that instructs a language model (126) to generate a desired output. The prompt (108) may include instructions, may refer to a context (a specific source of data), may include system messages (general guidelines to the language model regarding how the language model should process the prompt (108)), may include data references, may include or reference data structures, etc. In the case of one or more embodiments, the prompt (108) includes text for commanding a language model (126) (as defined below) to compare a context (110) (defined below) to the structured language data structure that constitutes the electronic form (102). The prompt (108) also instructs the language model (126) to identify an anomaly (112) (defined below) between the context (110) and the structured language data structure. Generation of the prompt is described with respect to step 202 of FIG. 2.

The data repository (100) also stores a context (110). The context (110) is a predetermined data source. The context (110) may be stored in the data repository (100), or may be stored externally. An example of the context (110) may be information describing tax rules and software applications which may be applied to the electronic form (102) to prepare a tax return when the electronic form (102) is an electronic tax form. Another example of the context (110) may be a specific knowledge base, such as a set of rules, policies, and information that are related to the electronic form (102). In any case, the context (110) contains information regarding the electronic form (102), rules applicable to processing the electronic form (102), software which may use or operate on the electronic form (102), information for generating links, etc.

The data repository (100) also stores an anomaly (112). The anomaly (112) is a determination by the language model (126) that the form data (106) in the field (104) of the electronic form (102) is anomalous for some reason as determined by the language model (126). An example of the anomaly (112) may be a determination by the language model (126) that the form data (106) in the field (104) violates a rule in the context (110). Another example of the anomaly (112) may be a determination by the language model (126) that the field (104) is improperly formatted. Another example of the anomaly (112) may be a determination by the language model (126) that the form data (106) is improperly formatted, incorrect, incomplete, or otherwise inappropriate in view of the information stored in the context (110).

The data repository (100) also stores a modified structured language data structure (114). The modified structured language data structure (114) is the electronic form (102) after modification by the server controller (124) (defined below) according to step 208 of FIG. 2. More specifically, the modified structured language data structure (114) includes additional computer code (116) that permits one or more computer processor(s) (122) (defined below), possibly via the server controller (124), to display a selectable link (118).

However, the computer code (116) also may include other instructions. For example, the computer code (116) may include computer-executable code for displaying a pop-up window displaying text describing a summary why the form data (106) in the field (104) of the electronic form (102) is anomalous. The pop-up window also may include instructions, or a summary of instructions, for correcting the anomaly (112) by modifying the form data (106). The pop-up window also may include instructions, or a summary of instructions, for selecting one of a number of different applications (128) (defined below) which may be used to correct the anomalous form data (106) in the electronic form (102). The pop-up window may include additional information which may be of assistance or interest to a user when considering the anomalous form data (106) in the electronic form (102).

The selectable link (118) is a widget displayable on, or part of, the electronic form (102). The selectable link (118), when displayed on a display device (134) (defined below), may be selected by a user in order to initiate a computer function. For example, the selectable link (118) may be used to launch a selected application from among the applications (128) (defined below). The selected application may be particularly applicable to correcting the anomalous form data (106) in the field (104) of the electronic form (102). However, the selectable link (118) may link to information in the context (110). In this case, when the selectable link (118) is selected by a user, the information in the context (110) that is appropriate to the anomalous form data (106) may be displayed to a user.

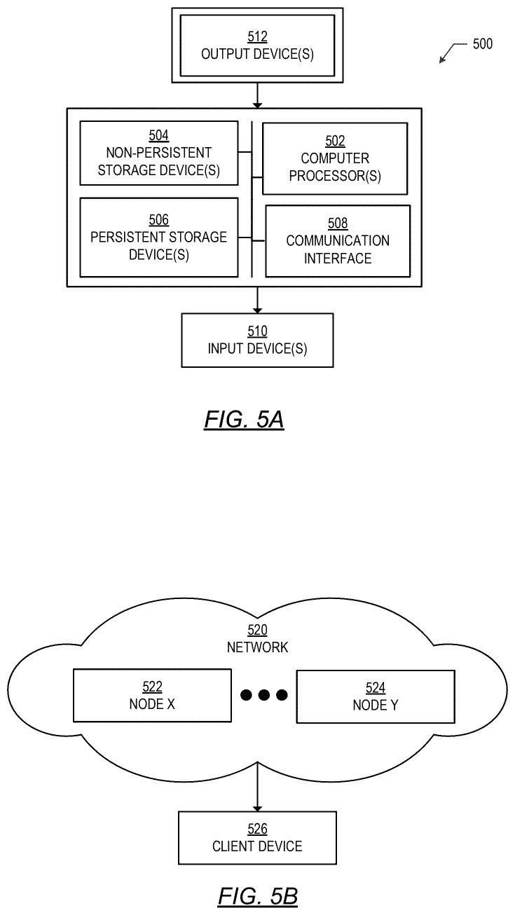

The system shown in FIG. 1A may include other components. For example, the system shown in FIG. 1A also may include a server (120). The server (120) is one or more computer processors, data repositories, communication devices, and supporting hardware and software. The server (120) may be in a distributed computing environment. The server (120) is configured to execute one or more applications, such as the server controller (124), the language model (126), or the applications (128). An example of a computer system and network that may form the server (120) is described with respect to FIG. 5A and FIG. 5B.

The server (120) includes one or more computer processor(s) (122). The one or more computer processor(s) (122) are one or more hardware or virtual processors which may execute computer readable program code that defines one or more applications, such as the server controller (124), the language model (126), or the applications (128). An example of the one or more computer processor(s) (122) is described with respect to the computer processor(s) (502) of FIG. 5A.

The server (120) also may include a server controller (124). The server controller (124) is software or application specific hardware which, when executed by the computer processor (122), controls and coordinates operation of the software or application specific hardware described herein. Thus, the server controller (124) may control and coordinate execution of the language model (126) and the applications (128). The server controller (124) is also code that, when executed by the computer processor(s) (122), performs the method shown in FIG. 2.

The server (120) also includes a language model (126). The language model (126) is a natural language processing machine learning model. An example of the language model (126) may be a large language model, such as CHATGPT® by Open AI. However, many different language models may be used. Use of the language model (126) is described with respect to FIG. 2.

The server (120) also includes one or more applications (128). The applications (128) may be computer programs which may generate, correct, or otherwise process the electronic form (102). The applications (128) also may be other types of applications that consume the server (120). For example, the applications (128) may be two or more tax applications that prepare tax returns for users, in which case the electronic form (102) may be a tax document. One of the tax applications processes tax forms of advanced complexity, and another of the tax applications processes tax forms that are comparatively simple.

Because the different applications may be more or less costly to users, or may be more or less expensive to execute in terms of computer resources consumed, the appropriate one of the applications (128) should be selected to mitigate the anomalous form data (106) in the electronic form (102). In one or more embodiments, as described with respect to FIG. 2, the modified structured language data structure (114) includes a selectable link (118) to the appropriate application among the applications (128) for mitigating the anomalous form data (106) in the electronic form (102).

The system shown in FIG. 1A also may include one or more user devices (130). The user devices (130) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A. In another embodiment, one or more of the user devices (130) may be operated by a computer technician that services the various components of the system shown in FIG. 1A.

In any case, the user devices (130) are computing systems (e.g., the computing system (500) shown in FIG. 5A) that communicate with the server (120). Thus, the user devices (130) include one more user input devices, such as user input device (132). The user devices (130) may be mice, keyboards, microphones, haptic devices, etc.

Additionally, the user devices (130) also include one or more display devices, such as the display device (134). The display device (134) may be a monitor, television, touchscreen, tablet, mobile device, etc. In an embodiment, display of the electronic form (102), the modified structured language data structure (114), the selectable link (118), the pop-up window described herein, or other information may be displayed on one or more display devices, such as the display device (134).

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for improving a user interface for identifying and displaying electronic form anomalies and launching a respective application accordingly, in accordance with one or more embodiments. The method of FIG. 2 may be implemented using the system of FIG. 1 and one or more of the steps may be performed on or received at one or more computer processors.

Step 200 includes receiving an electronic form as a structured language data structure storing form data in a number of fields. The electronic form may be received from a user device, a processing application (including one or more of the applications (128) of FIG. 1), or may be retrieved from a data repository (whether local or remote). The electronic form may be received via a communication interface (e.g., the communication interface (508) of FIG. 5A).

Step 202 includes generating a prompt including text for commanding a language model to compare a context to the structured language data structure to generate a comparison, and identify, based on the comparison, an anomaly between the context and the structured language data structure. The prompt may be generated according to a number of different methods, depending on the specific implementation of the system of FIG. 1.

In an embodiment, the prompt may be a predetermined prompt retrieved or sent from a data repository. The predetermined prompt may be selected from among many different prompts according to a standard or policy. For example, the predetermined prompt may be selected according to the type of the electronic form. In a more specific example, if the electronic form is a W-2 tax form (expressed as a structured language data structure), then a prompt designed for the W-2 tax form may be retrieved or sent from the data repository from among many different predetermined prompts stored for various different tax forms.

In another embodiment, the prompt may be generated from a prompt template. A prompt template contains general instructions to a language model, possibly together with one or more fields or blanks that may be filled-in depending on the specific implementation. For example, the prompt template may include general instructions, along with different fillable fields. The fillable fields may be filled with specific prompt instructions to the language model, depending on the type of the electronic form, the type of the fields being reviewed, the identity of the user, the type of application that uses or consumes the electronic form, or depending on some other basis. The fillable fields are then filled in accordingly, thereby resulting in a generated prompt.

In still another example, a prompt may be generated without using a prompt template. For example, a language model may be commanded to generate a prompt based on a predetermined prompt that instructs the language model, when executed, to generate a prompt for comparing the context to the structured language data structure and identifying an anomaly accordingly. In yet another example, a user may be requested to supply a prompt.

Still other actions may be taken when generating the prompt. For example, generating the prompt may include adding a second command to the prompt to summarize context text contained in the context that is related to the anomaly. For example, the prompt may instruct the language model to summarize rules, contained in the context, which pertain to any anomaly that the language model detects at step 204.

Step 204 includes executing the language model with the prompt to output the anomaly. Executing the language model may be performed by commanding a computer to execute the language model together with the prompt. In the example of the method of FIG. 2, part of the output of the language model at least includes the detection of one or more anomalies and an identification of the one or more fields in the electronic form which contain the one or more anomalies.

However, in a practical implementation, execution of the language model may result in an output that no anomaly exists in the electronic form. In the case that no anomaly exists, the method of FIG. 2 may terminate immediately.

In an embodiment, executing the language model may include additional functions performed by the language model according to the instructions in the prompt. Thus, for example, executing the language model also may include executing the language model with the second command to summarize the context text to generate summarized text. In this case, the method may further include displaying, together with the modified structured language data structure, the summarized text. Displaying the summarized text further includes displaying the summarized text as a pop-up window related to the field. However, the summarized text may be displayed in different ways, such as by displaying the summary in a separate display window, sending the summary in a chatbot, text, message, or email, or some other display mechanism.

Step 206 includes mapping a field of the fields to the anomaly. In particular, a server controller generates a data structure that stores the relationship between the anomaly and the field that contains the anomaly. For example, a table may indicate that “field X” contains “anomaly Y.” The mapping also may be stored as a structured language data structure, a graph database, or some other data structure that stores the mapping described above.

Step 208 includes modifying the structured language data structure to generate a modified structured language data structure: Modifying includes adding computer code to the structured language data structure. The computer code is programmed, when executed by a server controller, to add a selectable link to the field based on at least one of the anomaly, the structured language data structure, and the field. The selectable link, when selected, launches an application selected from among a number of applications.

The computer code also includes a reference to the mapping generated at step 206. In this manner, the server controller may use the mapping to associate the selectable link with the field that contains the anomaly.

Modification of the structured language data structure may take different forms. For example, the computer code may be programmed, when executed, to highlight the field in the electronic form when the electronic form is rendered on a display device at step 210. Additionally, the computer code, when executed, transforms the display of the field into a selectable widget. Thus, when a user selects the highlighted field rendered at step 210, the function of the selectable link associated with the field will perform the function associated with the link (e.g., launch an application from a number of different applications for mitigating the anomaly).

Step 210 includes rendering, on a display device, the modified structured language data structure, including rendering the field together with the selectable link. As indicated above, the field is rendered together with the selectable link by a number of different methods. In an embodiment, the field is highlighted to draw the attention of the user. The field has been made into a selectable widget that activates the function of the link, as mentioned above.

Step 210 also may include displaying, together with the modified structured language data structure, a rule stored in the context. The rule is related to the anomaly. The rule may be displayed as a clickable link to a portion of the context to which the rule belongs. The clickable link to the rule may be part of the selectable link generated at a step 208, ore may be a secondary link contained in a pop-up window that displays a summary of the rule. The rule may be displayed in a pop-up window, overlay, electronic message, or presented by some other technique (e.g., in a separate display area, etc.)

In any case, the modified electronic form, when displayed on a display device, includes a highlighted field that indicates the selectable link. The modified electronic form, when displayed on the display device, may further include a pop-up window that displays a text summary that summarizes a reason why the field contains the anomaly, or may include the full text of the reason or rule. Still other forms of rendering the modified data structure are possible.

The method of FIG. 2 may be varied. For example, the method of FIG. 2 may include additional steps, fewer steps, or modified steps. For example, the method of FIG. 2 also may include receiving a user selection of the selectable link. In this case, the method also includes executing, responsive to the user selection of the selectable link, the application on at least one of the structured language data structure and the modified structured language data structure. The application may be selected according to one of a type of the anomaly, a type of the structured language data structure, and a type of the field. In this manner, the anomaly may be mitigated, the electronic form may be remediated, and additional processing of the electronic form may continue.

Thus, for example, the method of FIG. 2 may be extended by editing, by the selected application, the field to further modify at least one of the structured language data structure and the modified structured language data structure. Editing generates a corrected structured language data structure. The corrected structured language data structure is then returned. Returning the corrected structured language data structure may be performed by passing the structured language data structure to another application for consumption or processing, by storing the corrected structured language data structure, by displaying or transmitting the structured language data structure, or some other additional computer process once the corrected structured language data structure is available.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

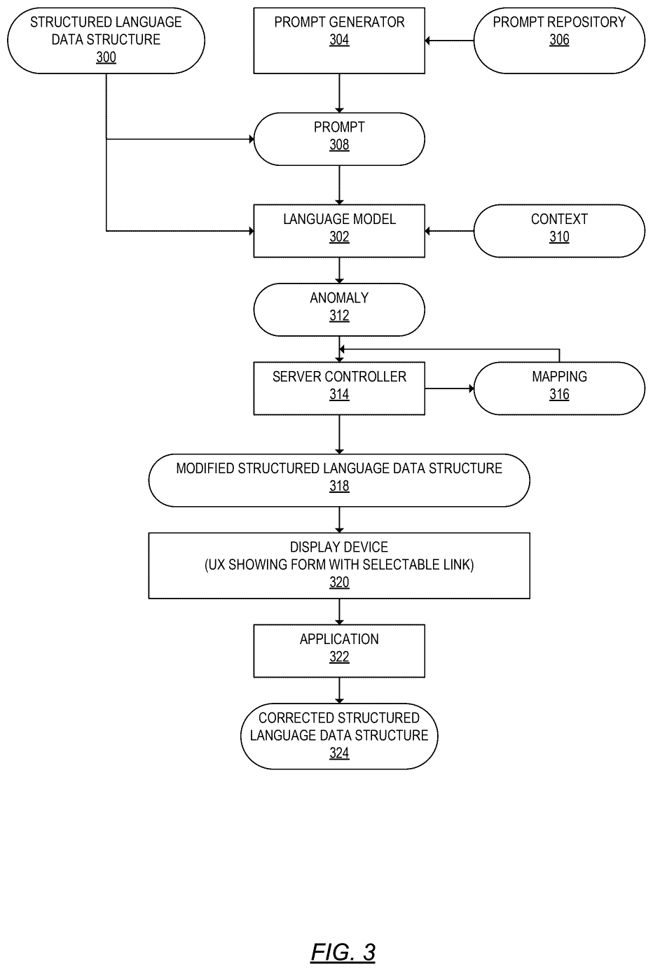

FIG. 3 shows a dataflow of a method for improving a user interface for identifying and displaying electronic form anomalies and launching a respective application accordingly, in accordance with one or more embodiments. The dataflow of FIG. 3 is a variation of the system of FIG. 1. The dataflow of FIG. 3 also is a variation of the method of FIG. 2. However, the dataflow of FIG. 3 also shows the software applications that perform the indicated computer steps, and thus shows inputs and outputs to the software applications.

In an embodiment, the process begins by receiving the structured language data structure (300). Additionally, a command is received to analyze the structured language data structure (300) for anomalies in the form data stored in fields of the structured language data structure (300). The structured language data structure (300), or a reference to the structured language data structure (300), is provided as input to a language model (302).

In addition, responsive to the command mentioned above, a prompt generator (304) retrieves a prompt template from a prompt repository (306). The prompt generator (304) modifies the prompt template according to the type of the structured language data structure (300). The prompt generator (304) generates a prompt (308), which is provided as input to the language model (302) together with the structured language data structure (300).

The prompt (308) contains a command to the language model (302) to reference a context (310) when executing with the prompt (308). In an example, the prompt (308) may command the language model (302) to consider the context (310) when determining whether one or more fields in the structured language data structure (300) contain an anomaly. In an embodiment, the prompt (308) also includes a command to the language model (302) to summarize, based on one or more rules or information contained in the context (310), why the language model (302) concluded that an anomaly (312) is present in the structured language data structure (300). In another embodiment, the prompt (308) also includes a command to summarize any rules or data in the context (310) that is pertinent to the anomaly (312), or to the field in the structured language data structure (300), or to the structured language data structure (300) itself.

In the example of FIG. 3, the output of the language model (302) is a finding of the anomaly (312). In other words, the language model (302) predicts that one or more fields in the structured language data structure (300) contains an anomaly that is in conflict with one or more rules or with information stored in the context (310).

The anomaly (312) is provided as input to a server controller (314). The server controller (314) generates a mapping (316) that maps the anomaly (312) to the field or fields that contain the anomaly (312). In turn, the server controller (314) uses the mapping (316) as input to a subsequent computing step in order to output the modified structured language data structure (318). Generation of the modified structured language data structure (318) may be similar to step 208 of FIG. 2.

The modified structured language data structure (318) then may be rendered. The modified structured language data structure (318) may be rendered by the server controller (314), by a web browser, or some other software programmed, when executed, to render a graphical user interface or an image on a display device.

Thus, the modified structured language data structure (318) is rendered on a display device (320). Specifically, the display device (320) shows a user interface (UX) showing the electronic form (defined by the modified structured language data structure (318)) together with the selectable link.

In the example of FIG. 3, a user (or some other process) selects the selectable link shown on the display device (320). As a result of the computer code referred to by the selectable link, selection of the selectable link launches an application (322). The application (322) is one or more applications selected from a greater set of applications. Thus, for example, the application (322) is selected from among multiple applications according to the programming referred to or contained in the selectable link.

In the example of FIG. 3, the user uses the application (322) to modify the structured language data structure (300) (or to modify the modified structured language data structure (318)). In either case, the application (322) is used to mitigate the field or the value of a field that resulted in the language model (302) identifying the anomaly (312). The output of the application (322) is a corrected structured language data structure (324). The corrected structured language data structure (324) no longer contains the anomaly, or the anomaly is mitigated in some manner.

In an embodiment, the dataflow may be repeated. Thus, for example, the corrected structured language data structure (324) may be checked again by repeating the dataflow shown in FIG. 3. The process may continue to iterate until the final version of the corrected structured language data structure (324) is predicted by the language model (302) to contain no anomalies.

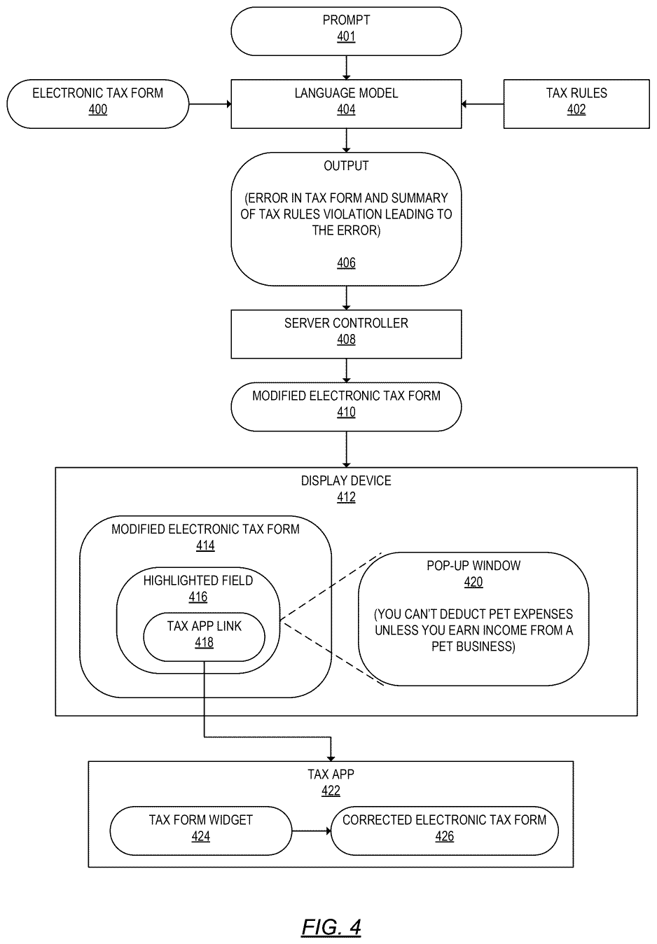

FIG. 4 shows an example of improving a user interface for identifying and displaying electronic form anomalies and launching a respective application accordingly, in accordance with one or more embodiments. The example of FIG. 4 is also a dataflow, and thus a variation of the dataflow shown in FIG. 3. The example of FIG. 4 is also a specific variation of the method of FIG. 2. The dataflow of FIG. 4 may be implemented using the system shown in FIG. 1.

The example of FIG. 4 is in the context of tax preparation software. The dataflow of FIG. 4 is used to check an electronic tax form (400), which is a prepared tax return. Note, however, that the example of FIG. 4 does not limit other embodiments, as the system of FIG. 1, the method of FIG. 2, and the dataflow of FIG. 3 are applicable to many different contexts in which electronic forms are processed and checked using the method of FIG. 2.

Initially, an electronic tax form (400) is provided as input to a language model (404), by way of a prompt (401) generated in a manner similar to step 204 of FIG. 2. The electronic tax form (400) is stored as a structured language data structure. The prompt (401) contains instructions to the language model (404) that, when executed, the language model (404) will consider a set of tax rules (402). The tax rules (402) is the context in the example of FIG. 4, and thus is an example of the context (110) shown in FIG. 1 or the context (310) shown in FIG. 3.

When executed with the prompt, the language model (404) generates an output (406). The output (406) identifies an anomaly in form data stored in a field of the electronic tax form (400). In particular, the output (406) is text that indicates that an error exists in the electronic tax form (400). The output (406) also contains text that summarizes tax rules (taken from the tax rules (402) context) which were violated on account of the value in the field of the electronic tax form (400), thereby leading to the error (i.e., the anomaly).

The output (406) is provided as input to a server controller (408). The server controller (408) generates a modified electronic tax form (410) according to the procedure described with respect to the procedure described with respect to step 208 and also described with respect to the modified structured language data structure (318) described in FIG. 2. Thus, the modified electronic tax form (410) includes computer code which will enable a rendering application (e.g., a web browser, a display driver, etc.) to display a selectable link associated with the field in the electronic tax form (400) that contains the anomaly (i.e., the error).

Thus, a display device (412) displays a modified electronic tax form (414). The modified electronic tax form (414) includes a highlighted field (416) among multiple fields of the electronic tax form (400). The highlighted field (416) is transformed by the computer code into a tax app link (418).

In addition, the computer code enables the rendering application to display a pop-up window (420). The pop-up window (420) shows a summary of a rule, contained in the tax rules (402), that the language model (404) predicts was violated by the form data contained in the field of the electronic tax form (400).

In the example, the summary in the pop-up window (420) is the text, “you can't deduct pet expenses unless you earn income from a pet business.” In the example, the electronic tax form (400) (i.e., the user's electronic tax return) contains no indication that the user owns a pet business. Thus, the language model (404) predicted that the deduction for a pet expense violated a rule in the tax rules (402) which constrains taxpayers from deducting pet expenses, except as part of running a business related to pets. The language model (404) generated the summary in the pop-up window (420) per the instructions contained in the prompt (401).

Next, a user selects the tax app link (418) by way of a user input device. In response, the computer code associated with the tax app link (418) generates a tax app (422). The tax app (422) is software or application specific hardware that is particularly helpful at resolving or mitigating the error (i.e., the anomaly) contained in the form data in the highlighted field (416) of the modified electronic tax form (414).

Thus, the user may select a tax form widget (424) to modify the form data associated with the highlighted field (416). A widget is a displayed object on a computer screen with which a user may interact in order to execute a computer function (e.g., a button, a drop-down menu, a wheel, etc.). The user uses the tax form widget (424) to correct the electronic tax form (400) (or to correct the modified electronic tax form (414)). As a result, the tax app (422) generates a corrected electronic tax form (426).

The corrected electronic tax form (426) may be re-checked by repeating the dataflow shown in FIG. 4. For example, the corrected electronic tax form (426) may be input to the language model (404) by way of the modified electronic tax form (410), in place of the electronic tax form (400). The dataflow may be repeated until the final version of the corrected electronic tax form (426) is predicted by the language model (404) to have no anomalies.

The corrected electronic tax form (426) then may be returned. Specifically, the corrected electronic tax form (426) may be filed electronically with the governmental body responsible for processing the tax return (e.g., the United States Internal Revenue Service (IRS)).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving an electronic form comprising a structured language data structure storing form data in a plurality of fields;
generating a prompt comprising text for commanding a language model to:
compare a context to the structured language data structure to generate a comparison, and
identify, based on the comparison, an anomaly between the context and the structured language data structure;
executing the language model with the prompt to output the anomaly;
mapping a field of the plurality of fields to the anomaly;
modifying the structured language data structure to generate a modified structured language data structure, wherein:
modifying comprises adding computer code to the structured language data structure,
the computer code is programmed, when executed, to add a selectable link to the field based on at least one of the anomaly, the structured language data structure, and the field, and
the selectable link, when selected, launches an application selected from among a plurality of applications; and
rendering, on a display device, the modified structured language data structure, including rendering the field together with the selectable link.

2. The method of claim 1, further comprising:
receiving a user selection of the selectable link; and
executing, responsive to the user selection of the selectable link, the application on at least one of the structured language data structure and the modified structured language data structure.

3. The method of claim 1, further comprising:
editing, by the application, the field to further modify at least one of the structured language data structure and the modified structured language data structure, wherein editing generates a corrected structured language data structure; and
returning the corrected structured language data structure.

4. The method of claim 1, wherein rendering further comprises:
displaying, together with the modified structured language data structure, a rule stored in the context, wherein the rule is related to the anomaly.

5. The method of claim 4, wherein the rule is displayed as a clickable link to a portion of the context to which the rule belongs.

6. The method of claim 1, wherein:
generating the prompt further comprises adding a second command to the prompt to summarize context text contained in the context, the context text being related to the anomaly,
executing the language model further comprises executing the language model with the second command to summarize the context text to generate summarized text, and
the method further comprises displaying, together with the modified structured language data structure, the summarized text.

7. The method of claim 6, wherein displaying the summarized text further comprises displaying the summarized text as a pop-up window related to the field.

8. The method of claim 1, wherein the application is selected according to one of a first type of the anomaly, a second type of the structured language data structure, and a third type of the field.

9. The method of claim 1, wherein the modified structured language data structure, when displayed on the display device, comprises a highlighted field that indicates the selectable link.

10. The method of claim 9, wherein the modified structured language data structure, when displayed on the display device, further comprises a pop-up window that displays a text summary that summarizes a reason why the field contains the anomaly.

11. The method of claim 1, wherein the anomaly comprises at least one of the structured language data structure being an incorrect electronic form, the anomaly comprises the field having an erroneous value, and an evaluation, by the language model, that the structured language data structure violates a rule stored in the context.

12. The method of claim 1, wherein:
the electronic form comprises a tax form,
the anomaly comprises a violation of a tax rule caused by an entry in the field, and
the modified structured language data structure, when displayed on the display device, highlights the field to indicate the selectable link.

13. The method of claim 12, wherein the modified structured language data structure, when displayed on the display device, further comprises a pop-up window that displays a text summary that summarizes a reason why the field contains the violation.

14. A system comprising:
a computer processor;
a plurality of applications executable by the computer processor;
a language model executable by the computer processor;
a data repository in communication with the computer processor and storing:
an electronic form comprising a structured language data structure storing form data in a plurality of fields including a field,
a prompt comprising text for commanding the language model,
a context,
an anomaly between the context and the structured language data structure,
a modified structured language data structure, and
computer code programmed, when executed, to add a selectable link to the field based on at least one of the anomaly, the structured language data structure, and the field, wherein the selectable link, when selected, launches an application selected from among the plurality of applications; and
a server controller which, when executed by the computer processor, performs a computer-implemented method comprising:
receiving the electronic form,
generating the prompt to command the language model to compare the context to the structured language data structure to generate a comparison and to identify, based on the comparison, the anomaly,
executing the language model with the prompt to output the anomaly,
mapping the field to the anomaly,
modify the structured language data structure to generate the modified structured language data structure having the computer code, and
generating a command to render, on a display device, the modified structured language data structure, including rendering the field together with the selectable link.

15. The system of claim 14, wherein the computer-implemented method further comprises:
transmitting the command and the modified structure language data structure to a remote user device.

16. The system of claim 15, wherein the computer-implemented method further comprises:
rendering the modified structured language data structure according to the command.

17. The system of claim 14, wherein the computer-implemented method further comprises:
receiving a user selection of the selectable link; and
executing the application on at least one of the structured language data structure and the modified structured language data structure.

18. The system of claim 17, wherein the computer-implemented method further comprises:
editing, by the application, the field to further modify at least one of the structured language data structure and the modified structured language data structure, wherein editing generates a corrected structured language data structure; and
returning the corrected structured language data structure.

19. The system of claim 14,
wherein, in the computer-implemented method:
generating the prompt further comprises adding a second command to the prompt to summarize context text contained in the context, the context text being related to the anomaly, and
executing the language model further comprises executing the language model with the second command to summarize the context text to generate summarized text, and
wherein the computer-implemented method further comprises displaying, together with the modified structured language data structure, the summarized text.

20. A method comprising:
receiving an electronic form comprising a structured language data structure storing form data in a plurality of fields;
generating a prompt comprising text for commanding a language model to:
compare a context to the structured language data structure to generate a comparison,
identify, based on the comparison, an anomaly between the context and the structured language data structure, and
add a second command to the prompt to summarize context text contained in the context to generate summarized text, the context text being related to the anomaly;
executing the language model with the prompt to output the anomaly and to generate the summarized text;
mapping a field of the plurality of fields to the anomaly;
modifying the structured language data structure to generate a modified structured language data structure, wherein:
modifying comprises adding computer code to the structured language data structure,
the computer code is programmed, when executed, to add a selectable link to the field based on at least one of the anomaly, the structured language data structure, and the field, and
the selectable link, when selected, launches an application selected from among a plurality of applications;
rendering, on a display device, the modified structured language data structure, including rendering the field together with the selectable link;
rendering, on the display device as associated with the field, the summarized text;
receiving a user selection of the selectable link;
executing, responsive to the user selection of the selectable link, the application on at least one of the structured language data structure and the modified structured language data structure;
editing, by the application, the field to further modify at least one of the structured language data structure and the modified structured language data structure, wherein editing generates a corrected structured language data structure; and
returning the corrected structured language data structure.
